(19) United States
(12) Patent Application Publication
(10) Pub. No.: US 2018/0328389 A1
(43) Pub. Date: Nov. 15, 2018

(54) Fastening Clamp

(71) Applicant: SIEMENS AKTIENGESELLSCHAFT, MUENCHEN (DE)

(72) Inventor: ALEXANDER BOCKAREV, BERLIN MARZAHN-HELLERSDORF (DE)

(21) Appl. No.: 15/775,887

(22) PCT Filed: Oct. 31, 2016
(86) PCT No.: PCT/EP2016/076184

§ 371 Date: May 14, 2018

(30) Foreign Application Priority Data
Nov. 12, 2015 (DE) 10 2015 222 346.9

(51) Int. Cl. F16B 2/06; F16B 2/12

(52) U.S. Cl. CPC F16B 2/065; B60M 1/24; F16B 2/12

(57) ABSTRACT

A fastening clamp for holding objects on a profiled support reliably secures the objects to the profiled support for extended periods of time. The clamp has two clamping brackets which are disposed opposite to each other in a clamping direction and delimit a clamping gap configured to receive a leg of the profiled support. At least one connection web is rigidly connected to the clamping brackets, a clamp element pressing device is connected to the clamping brackets and configured to generate a clamping force in the clamping direction, a transverse clamping unit is fastened to the clamping brackets or to one of the connection webs and has a clamping tongue configured to reach behind the profiled support, and a clamping tongue contact pressure device is connected to the transverse clamping unit and configured to apply a transverse clamping force to the clamping tongue.

The Invention Relates To A Fastening Clamp For Holding Objects On A Profiled Support.

Fastening clamps are known to a person skilled in the art from ongoing practical use. Previously known fastening clamps have clamping brackets which are held at a fixed mutual spacing and are specified for receiving a stationary profiled support. A clamping screw is provided on one of the clamping brackets, the position of said clamping screw being able to be arbitrarily adjusted in the clamping gap that is delimited by the clamping brackets. Should the clamping screw contact the profiled support, the desired clamping force can be generated by further rotation of the screw.

The previously known fastening clamps however have the disadvantage that the object, in particular when used outdoors, cannot be reliably held on the profiled support over a long period of time. The fastening clamp can be released by virtue of temperature variations and other weather-related influences. Moreover, the previously known fastening clamps have to be fixedly clamped to the profiled support with great care.

It is therefore an object of the invention to provide a fastening clamp which enables a reliable grip on a profiled support even over a long period of time, wherein the fastening clamp can be attached to the profiled support in a rapid and reliable manner.

This object is achieved according to the invention by a fastening clamp which has clamping brackets which in a clamping direction are mutually opposite and which delimit a clamping gap which is specified for receiving a leg of the profiled support; at least one connection web which is fixedly connected to the clamping brackets; bracket contact pressure means which are connected to the clamping brackets and are specified for generating a clamping force in the clamping direction; a transverse clamping unit which is fastened to the clamping brackets or one of the connection webs and which also has a clamping tongue that is specified for engaging behind the profiled support; and clamping tongue contact pressure means which are connected to the transverse clamping unit and are specified for introducing a transverse clamping force into the clamping tongue.

According to the invention, a fastening clamp which has two clamping brackets which delimit a clamping gap is provided. The clamping gap serves for receiving a leg of the profiled support. The two clamping brackets in the context of the invention are fixedly interconnected. A so-called connection web which extends between the clamping brackets and interconnects the latter in a rigid manner serves for this purpose. A clamping force can thus be generated by activating the bracket contact pressure means, said clamping force running in a direction which here is referred to as the clamping direction. To this extent, the fastening clamp does not differ from fastening clamps that are commercially available. However, the fastening clamp according to the invention moreover comprises a transverse clamping unit which is equipped with a clamping tongue. The clamping tongue is specified for engaging behind the profiled support, wherein clamping tongue contact pressure means which are connected to the transverse clamping unit and are specified for introducing a second force component, a so-called transverse clamping force, into the clamping tongue are provided.

The fastening clamp in the context of the invention therefore comprises not only one, but two clamping mechanisms, such that according to the invention two clamping forces, the clamping force and the transverse clamping force, can be generated. On account of this double clamping of the fastening clamp to an arbitrary profiled support, the fastening clamp can be fastened in a far more reliable manner to the profiled support, such that objects that are attached to the fastening clamp according to the invention can also be held over comparatively long time periods in the outdoor atmosphere in almost arbitrary weather conditions.

In the clamped state, part of the profiled support is located in the clamping gap that is delimited by the clamping brackets. However, the profiled support herein extends out of the clamping gap. The clamping tongue in relation to the clamping gap is disposed at a transverse spacing such that the portion of the profiled support that extends out of the clamping gap can be engaged from behind by the clamping tongue. By activating the clamping tongue contact pressure means, the profiled support is pressed in the direction of the transverse clamping force onto the clamping gap and against the locationally fixed clamping brackets such that the desired second force component, the transverse clamping force, is generated. Any sliding out of the clamping gap is thus prevented by the clamping tongue.

According to one preferred design embodiment of the invention, the clamping tongue extends in the clamping direction. This enables a reliable engagement from behind of the profiled support.

According to one preferred design embodiment of the invention, the clamping force and the transverse clamping force are aligned so as to be mutually orthogonal. In principle, the alignment or the angle which is jointly defined by the clamping force and the transverse clamping force is arbitrary. However, an orthogonal alignment of the forces simplifies the assembly of the fastening clamp and moreover provides the highest degree of safety in order for any sliding-off of the fastening clamp from the profiled support to be able to be avoided.

Two connection webs which in each case interconnect the clamping brackets are advantageously provided. Providing two connection webs simplifies the generation of the transverse clamping force. In the use of two connection webs it is thus possible, for example, for said two connection webs to be interconnected by way of a locationally fixed counter bearing. This locationally fixed counter bearing expediently interacts with the clamping tongue contact pressure means which can be supported on said counter bearing.

Each connection web advantageously has two clamping bracket portions that are in each case fixedly connected to one clamping bracket, and an arcuate central portion which interconnects the two clamping bracket portions. According to this variant of the invention, the clamping brackets are positioned between the connection webs that are disposed so as to be mutually aligned. The arcuate central portion establishes the required rigid connection between the connection webs. According to this refinement, the fastening clamp according to the invention is configured so as to be particularly compact and can thus be readily fastened to the profiled support.

According to one preferred design embodiment of the invention, each clamping bracket portion on that side thereof that faces away from the respective clamping bracket configures a fastening flange. The fastening flange serves for fastening the object. The object can be, for example, an electronic component for the distribution or transmission of power. High safety requirements are typically set for the fastening of heavy electronic components to profiled supports, said safety requirements having to be met by the fastening clamp. The profiles of utility poles can be considered as profiled supports in the context of the invention, for example. These are typically L-profiles which have two free legs which extend in a substantially orthogonal manner to one another and which at one side are rigidly and fixedly interconnected. The fastening flange extends parallel with the clamping brackets, for example, such that a fastening face which extends parallel with the profiled support is provided.

The bracket contact pressure means expediently have an external thread which engages with an internal thread disposed in one of the ties. The clamping force can thus be generated in a simple manner by screwing or rotating the bracket contact pressure means, for example a simple clamping screw.

According to one preferred design embodiment of the invention, the transverse clamping unit has a Z-profile, wherein the clamping tongue is a free leg of said Z-profile. The Z-profile moreover has a second free leg. The second free leg is furthermore connected to the clamping tongue by way of a central portion. The second free leg is equipped with clamping tongue contact pressure means, wherein transverse guiding means provide guiding of the Z-profile in the direction of the transverse clamping force. The transverse guiding means serve for the movable fastening of the Z-profile to the locationally fixed components of the fastening clamp, thus the clamping brackets or at least one of the clamping webs, on the one hand. Moreover, guiding is provided in a direction which determines the direction of the transverse force and thus is co-linear with the latter. A displacement of the clamping tongue in the direction of the guide thus takes place by activating the clamping tongue contact pressure means. Finally, the clamping tongue contacts the portion of the profile that protrudes from the clamping gap. By further activating the clamping tongue contact pressure means, said clamping tongue is firmly pressed against the profiled support such that the transverse clamping force as has already been described above is provided.

The transverse guiding means advantageously have an elongate bore configured in the central portion, wherein a holding shank extends through the elongate bore, said holding shank being fixedly connected to a clamping bracket and holding the transverse clamping unit on the clamping bracket. Such an elongate bore is a particularly cost-effective and simple transverse guiding means.

Further expedient design embodiments and advantages of the invention are the subject matter of the following description of exemplary embodiments of the invention with reference to the figures of the drawing, wherein the same reference signs refer to functionally equivalent components, and wherein

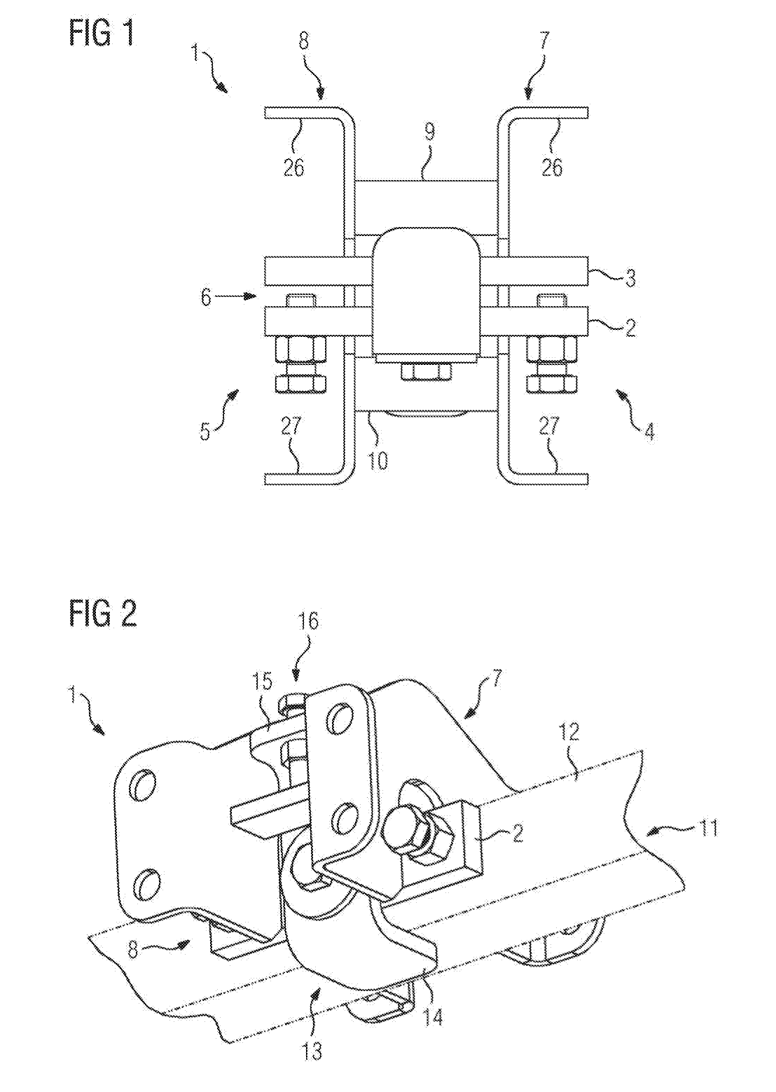

FIG. 1 shows an exemplary embodiment of the fastening clamp according to the invention in a frontal view;

FIG. 2 shows a perspective view of the fastening clamp as per FIG. 1, said fastening clamp being assembled on an L-profile;

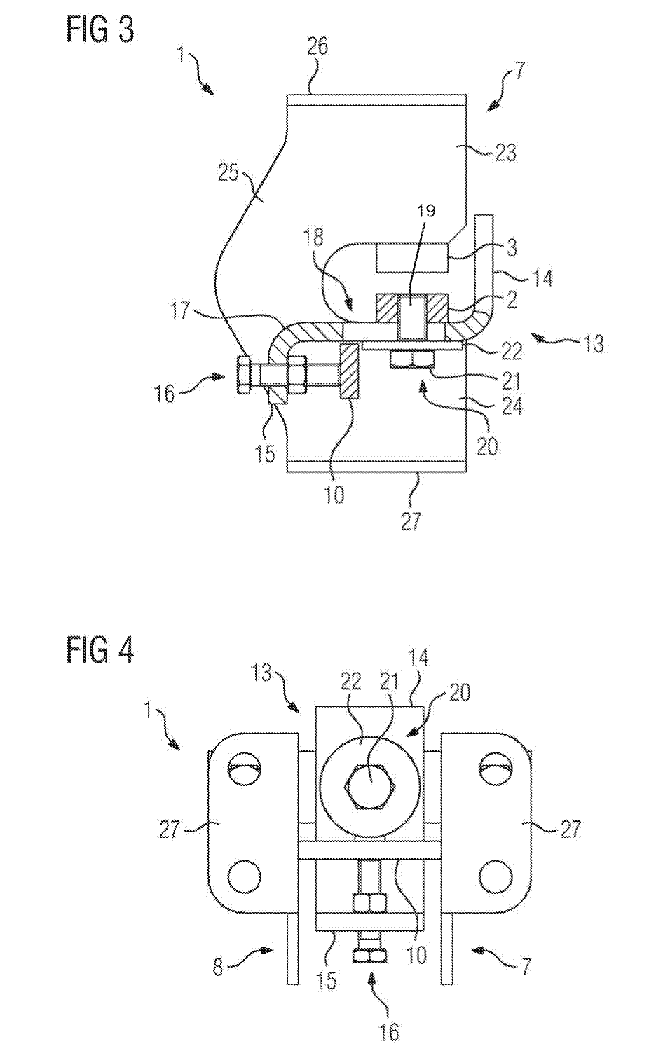

FIG. 3 shows a cross-sectional view of the fastening clamp according to FIG. 2; and

FIG. 4 shows the fastening clamp according to FIG. 3 from below.

FIG. 1 shows an exemplary embodiment of the fastening clamp 1 according to the invention in a frontal or front view. The fastening clamp has two clamping brackets 2 and 3 which in a clamping direction are mutually opposite, wherein two clamping screws 4 and 5 are provided as bracket contact pressure means in the clamping bracket 2. The clamping bracket 2 in the two lateral external regions thereof has two through openings which are provided with an internal thread (not illustrated). The clamping screws 4 and 5 have an external thread (likewise not illustrated in the figures) by way of which said clamping screws 4 and 5 engage in the internal thread of said through openings. The clamping brackets 2 and 3 delimit a clamping gap 6 which is provided for receiving a leg of a profiled support.

The clamping brackets 2 and 3 are rigidly interconnected by connection webs 7 and 8, said connection webs 7 and 8 in turn being rigidly interconnected by an upper transverse web 9 and a counter bearing 10.

FIG. 2 shows the fastening clamp 1 in a perspective view, wherein said fastening clamp 1 is fixedly clamped to an L-profile 11. The L-profile 11 has a free leg 12 by way of which the L-profile 11 extends into the clamping gap 6. A clamping force is generated by rotating the clamping screws 4 and 5. Moreover, a Z-profile 13 can be seen as a transverse clamping unit, wherein the Z-profile 13 has a clamping tongue 14 as the first free leg and a second free leg 15, the free ends of said legs facing away from one another. Clamping tongue contact pressure means 16 which are specified for generating a transverse clamping force are provided on the second free leg 15. The clamping tongue contact pressure means 16 in the exemplary embodiment shown are configured as a transverse clamping screw 16. The transverse clamping screw 16 has an external thread which is not illustrated in the figures. The external thread engages in the internal thread of a through opening which is provided in the second free leg 15. The fastening clamp 1 in the exemplary embodiment shown in FIG. 2 is shown in a position in which the transverse clamping screw 16 is in contact with the counter bearing 10. The second free leg 15 and the clamping tongue 14 are interconnected by way of a central portion, reference to the latter to be made in yet more detail below.

FIG. 3 shows the fastening clamp according to FIG. 2 in a cross-sectional lateral view. The construction of the Z-profile 13 can be particularly readily seen in this illustration. It is highlighted in particular that the Z-profile 13, besides the clamping tongue 14, has the second free leg 15, the former and the latter extending in different directions. A central portion 17 which connects the second free leg 15 to the clamping tongue 14 can moreover be seen. An elongate bore 18 is configured within the central portion 17. A holding shank 19 of a fastening screw 20 which engages in a clearance that is provided with an internal thread in the clamping bracket 4 extends through the elongate bore 18. A washer 22 can be seen between a fastening screw head 21 and the central portion 17 of the Z-profile 13. The elongate bore 18, the fastening screw 20, and the washer 22 provide the transverse guiding means which enable a movement of the Z-profile 13 in a transverse direction, said Z-profile 13 by rotating the transverse clamping screw 16 contacting the locationally fixed counter bearing 10, wherein the longitudinally guided clamping tongue 14 in FIG. 3 is moved to the left. If an L-profile is located in the clamping gap 6, the clamping tongue 14 engages the L-profile from behind, wherein finally a transverse clamping force is provided which extends orthogonally to the clamping force by way of which the free leg of the L-profile that is disposed in the clamping gap 6 is impinged.

It can moreover be seen that the connection webs 7 and 8 have in each case one clamping bracket portion 23 and 24, each fixedly connected to a clamping bracket 2 or 3, respectively. The clamping bracket portions 23 and 24 are interconnected by way of an arcuate central portion 25. In each case one fastening flange 26 and 27 is configured on the clamping bracket portions 23 and 24. Objects can be fastened to the fastening flange 26 or 27 and can thus be held by said profile.

FIG. 4 shows the counter bearing according to FIG. 3 in a view from below, in which the fastening flange 27 is particularly well highlighted. It can be seen in particular that the fastening flange 27 has assembly openings which serve for fastening an arbitrary object.

1-9. (canceled)

10. A fastening clamp for holding objects on a profiled support, the fastening clamp comprising:
clamping brackets disposed mutually opposite in a clamping direction, said clamping brackets delimiting a clamping gap configured for receiving a leg of the profiled support;
at least one connection web fixedly connected to said clamping brackets;
a bracket contact pressure device connected to said clamping brackets and configured for generating a clamping force in the clamping direction;
a transverse clamping unit fastened to said clamping brackets or to one of said at least one connection web, said transverse clamping unit having a clamping tongue configured for engaging behind the profiled support; and
a clamping tongue contact pressure device connected to said transverse clamping unit and configured for introducing a transverse clamping force into said clamping tongue.

11. The fastening clamp according to claim 10, wherein said clamping tongue extends in the clamping direction.

12. The fastening clamp according to claim 10, wherein the clamping force and the transverse clamping force are oriented to be mutually orthogonal.

13. The fastening clamp according to claim 10, wherein said at least one connection web includes two connection webs each interconnecting said clamping brackets.

14. The fastening clamp according to claim 13, wherein each of said connection webs includes:
two clamping bracket portions each being fixedly connected to a respective one of said clamping brackets; and
an arcuate central portion interconnecting said two clamping bracket portions.

15. The fastening clamp according to claim 14, wherein each of said clamping bracket portions has a side facing away from a respective one of said clamping brackets, and each of said clamping bracket portions has a fastening flange on said side of a respective one of said clamping bracket portions.

16. The fastening clamp according to claim 15, wherein said bracket contact pressure device has an external thread engaging with an internal thread in one of said clamping brackets.

17. The fastening clamp according to claim 10, wherein:
said transverse clamping unit has a Z-shaped profile,
said clamping tongue is a free leg of said Z-shaped profile;
said Z-shaped profile has a further free leg connected to said clamping tongue contact pressure device;
said Z-shaped profile has a central portion extending between said free legs of said Z-shaped profile; and
a transverse guiding device guides said Z-shaped profile so as to be movable in the direction of the transverse clamping force.

18. The fastening clamp according to claim 17, wherein said transverse guiding device includes an elongate bore formed in said central portion, a holding shank extends through said elongate bore, and said holding shank is fixedly connected to one of said clamping brackets and holds said transverse clamping unit on said one clamping bracket.
